(19) United States
(12) Patent Application Publication
(10) Pub. No.: US 2014/0174949 A1
(43) Pub. Date: Jun. 26, 2014

(54) ELECTROCHEMICAL AFFINITY SENSOR

(71) Applicant: NewSouth Innovations Pty Limited, Sydney (AU)

(72) Inventors: Justin Gooding, Queens Park (AU); Guozhen Liu, Shenzhen City (CN)

(73) Assignee: NewSouth Innovations Pty Limited, Sydney (AU)

(21) Appl. No.: 14/192,994

(22) Filed: Feb. 28, 2014

Related U.S. Application Data
(63) Continuation of application No. PCT/AU2012/001031, filed on Aug. 31, 2012.

(30) Foreign Application Priority Data
Sep. 1, 2011 (AU) 2011903529

(51) Int. Cl. G01N 27/327

(52) U.S. Cl. CPC G01N 27/3271
USPC 205/777.5; 204/400; 204/403.01; 205/782

(57) ABSTRACT

An electrochemical sensor comprising an electrode having a protective layer; conductive nanoparticles bound to the protective layer; a redox active species bound to the conductive nanoparticles; and a binding moiety capable of associating with an analyte, the binding moiety being associated with the redox active species bound to the conductive nanoparticles. Association of a binding moiety with the analyte modulates the electrochemistry of the redox active species.

### BACKGROUND OF THE INVENTION

The present invention relates to electrochemical sensors and to methods for detecting the presence of an analyte in a sample.

A number of electrochemical techniques for detecting the presence of an analyte in a sample have been described. These techniques can be classified as catalytic, where reaction of a modified electrode with an analyte produces a new species which can be detected electrochemically, or affinity based, where a binding reaction between an analyte and its binding partner is detected electrochemically.

With affinity based techniques, an enduring challenge has been to detect that the binding event has occurred. Typically, this is achieved using some sort of redox-labelled species that enables differentiation between before and after binding of the analyte. For many affinity based techniques, a redox-labelled species or a species capable of generating a redox active species must be added to the sample at some stage during the analysis in order for the binding event to be electrochemically detectable. It is therefore necessary for a person using the sensor to intervene at a specific point during the analysis, and thus operators of these sensors must be skilled.

International application no. PCT/AU2007/000337 (WO 2007/106936) describes an affinity based electrochemical sensor capable of detecting the association of an analyte with a binding partner. Sensors exemplified in WO 2007/106936 comprise a binding partner bound to a redox active species that is itself bound to the surface of an electrode via a molecular wire or carbon nanotube. In these sensors, the molecular wire or carbon nanotube acts as a long conduit for electron transfer and positions the binding partner well clear of the electrode (and any antifouling molecules present on the electrode) so that it is accessible for binding to the analyte. The inventors have found, however, that the sensors including molecular wires or carbon nanotubes suffer the disadvantages of being unstable in air and/or difficult to synthesise in large quantities. Furthermore, the inventors have found that some sensors with carbon nanotubes are difficult to assemble.

### SUMMARY OF THE INVENTION

In a first aspect, the present invention provides an electrochemical sensor. The sensor comprises an electrode having a protective layer; conductive nanoparticles bound to the protective layer; a redox active species bound to the conductive nanoparticles; and a binding moiety capable of associating with an analyte, the binding moiety being associated with the redox active species bound to the conductive nanoparticles. Association of a binding moiety with the analyte modulates the electrochemistry of the redox active species.

Conductive nanoparticles have useful physicochemical characteristics, such as a high surface-to-volume ratio, good biocompatibility, and the ability to facilitate electron transfer. Conductive nanoparticles attached to otherwise passivating layers or monolayers (e.g. self assembled layers or monolayers) on an electrode open up conducting channels through which electron transfer can proceed as though the protective layer was not even present. The inventors have discovered that conductive nanoparticles bound to a protective layer on an electrode electrochemically link the electrode with a redox active species bound to the conductive nanoparticles. As conductive nanoparticles are, in general, very stable and durable, the sensors of the present invention are easier to produce, more durable and hence longer lasting than sensors which utilise other species that are conduits for electron movement (e.g. molecular wires and carbon nanotubes).

The electrochemical sensors of the present invention can be used to determine whether an analyte is present or absent in a sample. The sensors can also be used to quantify the amount of the analyte in a sample.

The electrochemical sensor of the present invention exploits the changes in electrochemistry of the redox active species which occur when the binding moiety associates with the analyte. As the redox active species is bound to the conductive particle and is electrochemically accessible to the electrode, it is provided as an integral part of the sensor and the changes in its electrochemistry occur (and are detectable) without the need to add additional redox active species (or species capable of reacting to generate a redox active species) during analysis of a sample.

Typically, amperometric electrochemical measurements are taken at the same time that the sensor is exposed to a sample, that is, at the same time that the binding moiety associates with the analyte (i.e. association of the binding moiety with the analyte can be electrochemically contemporaneously detected), which can significantly simplify the detection process.

In a first embodiment, the analyte is an antigen and the binding moiety comprises an antibody for the antigen. When the sensor, and therefore the antibody binding moiety, is exposed to a sample comprising the antigen analyte the antibody binding moiety dissociates from the redox active species (and hence the sensor) in order to associate with the antigen analyte. Dissociation of the antibody binding moiety from the redox active species increases the electrochemistry of the redox active species associated with the binding moiety.

In a second embodiment, the analyte is an antibody and the binding moiety comprises at least part of an antigen for the antibody. When the sensor, and therefore the antigen binding moiety, is exposed to a sample comprising the antibody, the antibody binds to the binding moiety on the sensor. Binding of antibody analyte to the binding moiety suppresses the electrochemistry of the redox active species associated with the binding moiety.

The sensor of the second embodiment may be used to detect a species using a “competitive inhibition assay”, as described below.

In a second aspect, the present invention provides a method for detecting the presence of an analyte in a sample. The method comprises the steps of exposing the electrochemical sensor of the first aspect to the sample and taking amperometric electrochemical measurements which indicate whether the electrochemistry of the redox active species has been modulated.

As mentioned above, it is not necessary for a user to perform further steps when testing a sample for the analyte. Accordingly, in some embodiments, the method consists essentially of, or consists only of, the steps referred to above.

In a third aspect, the present invention provides a method for determining blood glucose levels in a patient. The method comprises the steps of adding to a sample of the patient's blood an antibody of HbA1c; exposing to the sample a sensor of the first aspect in which the binding moiety is capable of associating with the antibody of Hb1Ac; and taking amperometric electrochemical measurements which indicate whether the electrochemistry of the redox active species has been modulated by the binding moiety associating with the antibody of HbA1c.

In a fourth aspect, the present invention provides a kit comprising a sensor of the first aspect and an analyte that is an antibody of a second analyte. In some embodiments, the second analyte is HbA1c.

### BRIEF DESCRIPTION OF THE DRAWINGS

In the following detailed description, the following Figures are referred to, in which:

FIG. 1a shows a schematic representation illustrating the use of a sensor in accordance with the first embodiment of the sensor of the present invention;

FIG. 1b shows a schematic representation illustrating the use of a sensor in accordance with the second embodiment of the sensor of the present invention;

FIG. 1c shows a schematic representation illustrating the use of a sensor in accordance with the second embodiment of the sensor of the present invention in a “competitive inhibition assay”;

FIG. 2 shows a schematic representation illustrating the fabrication of an electrochemical sensor in accordance with the second embodiment of the present invention;

FIG. 3 shows a schematic representation of an embodiment of the electrochemical sensor of the present invention; and

FIG. 4 shows exemplary square wave voltammograms (SWV) for the electrode of an electrochemical sensor comprising an electrode having a redox active species bound to the electrode via a gold nanoparticle (a) after the attachment of N-glycosylated VHLTP (an epitope for the antibody of HbA1c) to the redox active species; (b) after exposure of the electrode of (a) to anti-HbA1c IgG (the antibody of HbA1c); and (c) after exposure of the electrode of (a) to BSA.

### DETAILED DESCRIPTION

In a first aspect, the present invention provides an electrochemical sensor. The sensor comprises an electrode having a protective layer; conductive nanoparticles bound to the protective layer; a redox active species bound to the conductive nanoparticles; and a binding moiety capable of associating with an analyte, the binding moiety being associated with the redox active species bound to the conductive nanoparticles. Association of a binding moiety with the analyte modulates the electrochemistry of the redox active species.

In a first embodiment, the analyte is an antigen and the binding moiety comprises an antibody for the antigen. When the antibody binding moiety is exposed to a sample comprising the antigen analyte the binding moiety dissociates from the redox active species (and hence the sensor) in order to associate with the antigen analyte. Dissociation of the antibody binding moiety from the redox active species increases the electrochemistry of the redox active species associated with the binding moiety.

Typically, the antibody is associated with the redox active species via at least part of an antigen for the antibody. Typically, the at least part of the antigen is chemically bound to the redox active species (e.g. via chemical coupling reactions) and the antibody binding moiety is associated with the at least part of the antigen via the intermolecular bonding forces and steric interactions responsible for recognition between the molecules of the binding pair. Thus, in order for the antibody binding moiety to dissociate from the sensor, the analyte must be a molecule with which the antibody binding moiety has a very high affinity (e.g. its antigen). Such sensors therefore typically have a high degree of selectivity for a specific antigen analyte, and have little susceptibility to interference from other species which may be present in the sample.

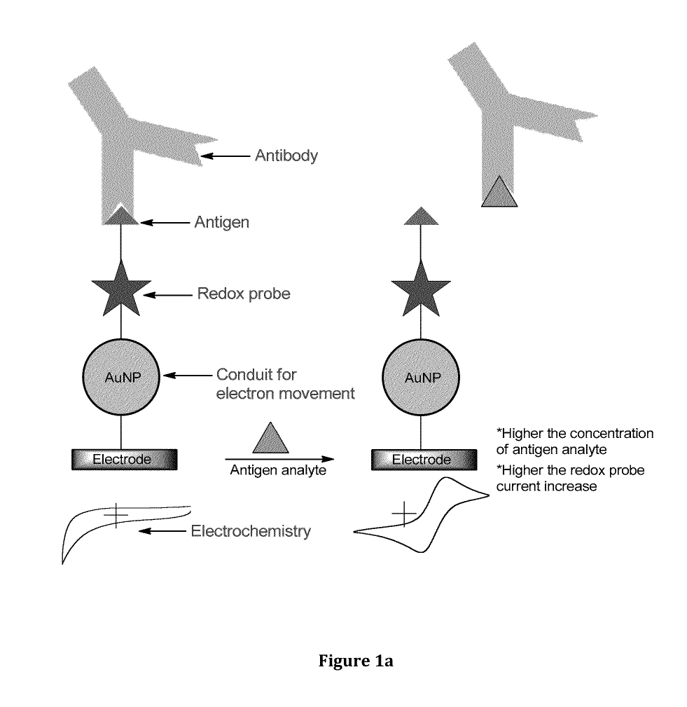

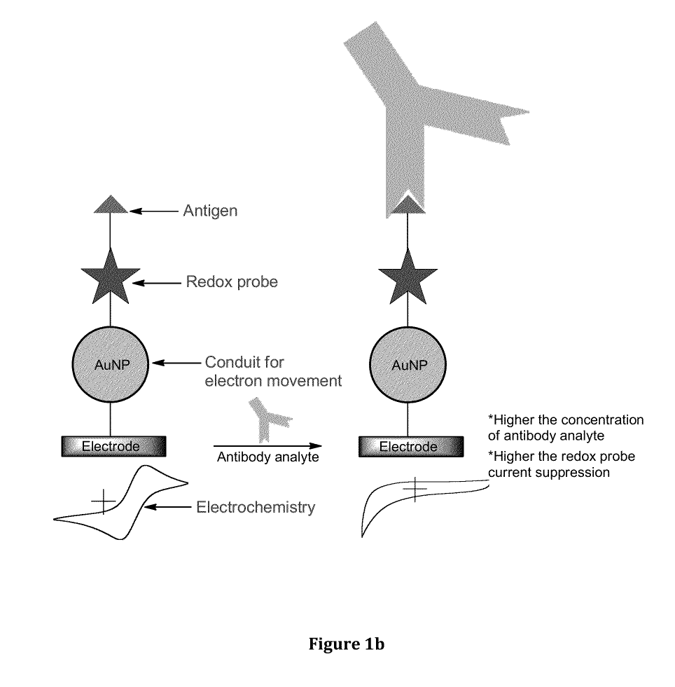

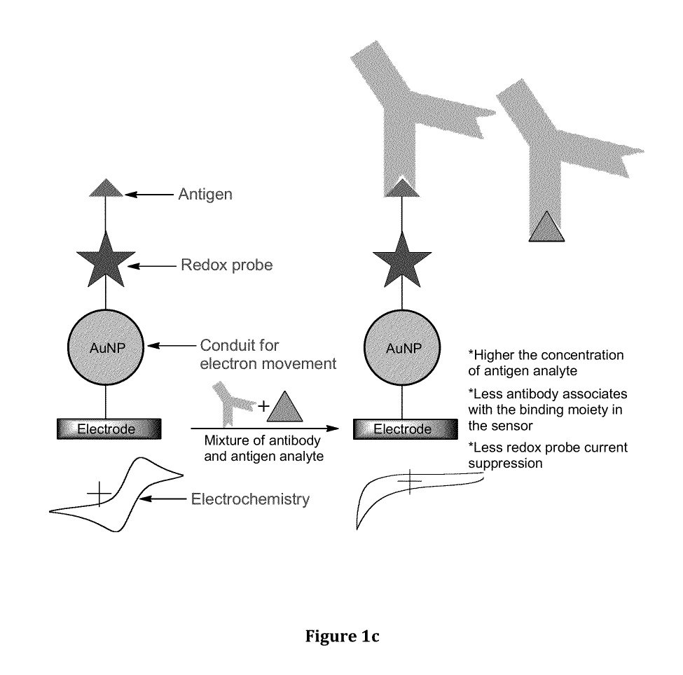

As depicted in FIG. 1a, when the sensor of the first embodiment is exposed to a sample that contains the antigen analyte, a competition for the antibody binding moiety occurs between the sensor and the antigen in the sample. As a result of this competition, at least some of the antibody binding moieties detach from the sensor, which results in the redox active species associated with those binding moieties becoming more exposed to ions in the sample. Without wishing to be bound by theory, the inventors believe that the electrochemistry of the redox active species is suppressed whilst the binding moiety is associated with the redox active species, because ions in the sample are restricted from interacting with the redox active species as the relatively large antibody enfolds the redox active species and effectively “shields” the redox active species from ions in the sample. However, when the binding moiety associates with the analyte and dissociates from the redox active species, ions in the sample are no longer restricted from interacting with the redox active species and the electrochemistry of the redox active species therefore increases. The increase in the electrochemistry of the redox active species is detectable using electrochemical techniques and may be quantified. Thus, transduction of the affinity based recognition event (i.e. the binding moiety dissociating from the sensor in order to bind to the antigen analyte) is achieved simply by exposing the sensor to the sample and passing an electrical current through the electrode, and no further intervention from the user is required.

In a second embodiment, the analyte is an antibody and the binding moieties comprise at least part of an antigen for the antibody. When the antigen binding moiety is exposed to a sample comprising the antibody, the antibody binds to the binding moieties on the sensor. Binding of antibody analyte to the at least part of the antigen binding moiety suppresses the electrochemistry of the redox active species associated with the binding moiety. Typically, the antibody analyte binds to the at least part of the antigen binding moiety via the intermolecular bonding forces and steric interactions responsible for recognition between the molecules of the binding pair.

As depicted in FIG. 1b, when the sensor of the second embodiment is exposed to a sample that contains the antibody analyte, the antibody in the sample binds to the binding moiety of the sensor. Without wishing to be bound by theory, the inventors believe that the electrochemistry of the redox active species associated with the binding moiety is suppressed following binding, because ions in the sample are restricted from interacting with the redox active species as the relatively large antibody enfolds the redox active species and effectively “shields” the redox active species from ions in the sample. This suppression of the electrochemistry of the redox active species is detectable using electrochemical techniques and may be quantified.

In some embodiments, the at least part of the antigen comprises an epitope for the antibody in order to provide a sensor adapted to associate with a high degree of specificity with only the antibody analyte.

As discussed above, in the first embodiment, detecting an antigen analyte in a sample relies on the antibody binding moiety disassociating from the sensor. The inventors have found that in some circumstances, the dissociation of the antibody binding moiety from the sensor when exposed to a sample containing the analyte is limited, limiting the sensitivity of such sensors. For example, the inventors have discovered that the relevant antibody unexpectedly does not readily dissociate from the sensors of the first embodiment when the antigenic species is a protein, rather than a small molecule below 1000 Da. Glycosylated haemoglobin (HbA1c), for example, is one such protein which the inventors have found cannot be detected with high sensitivity using the sensors of the first embodiment. Furthermore, such analytes are not capable of directly binding to a sensor of the second embodiment.

The inventors have developed a “competitive inhibition assay” using the sensors of the second embodiment which can be used to detect such analytes.

In the “competitive inhibition assay”, the “analyte” is, in fact, the antibody of the species that is sought to be detected. As depicted in FIG. 1c, in the “competitive inhibition assay”, the antibody of the species that is to be detected is first added to the sample, after which the sensor of the second embodiment is added to the sample. Alternatively, the sensor and antibody could be exposed/added to the sample at the same time, or the sensor could be exposed to the sample first and the antibody added to the sample at a later time. The antibody added to the sample can then bind to either any of the species that is to be detected which is present in the sample or to the binding moiety associated with the redox active species on the sensor. Based on a comparison of the amount of the antibody added to the sample with the amount of antibody which becomes associated with the binding moiety (and is thus detectable by taking amperometric electrochemical measurements), an indication of the presence and amount of the species that is to be detected in the sample can be obtained.

The “competitive inhibition assay” detects the binding of the antibody added to the sample to the binding moiety, and therefore does not require an antibody binding moiety to dissociate from the binding moiety (which the inventors have found may not occur to an appropriate degree in all cases) in order to detect the presence of the species that is to be detected.

In some embodiments, the analyte may, for example, be an antibody of HbA1c (i.e. the sensor is, in effect, being used to detect HbA1c in a sample via the “competitive inhibition assay”). HbA1c is a stable minor haemoglobin variant formed by a non-enzymatic reaction of glucose with the N-terminal valine of an adult's haemoglobin β chain in the human body. The percentage of haemoglobin in a patient's blood that is glycosylated (i.e. HbA1c) has been found to be useful because it provides an indication of that patient's average blood sugar level over the preceding 2 to 3 months. A direct relationship between HbA1c and diabetic complications has been observed and recent guidelines for the management of diabetes now stress the importance of monitoring HbA1c levels.

In such embodiments, the binding moiety may comprise an epitope for an antibody of HbA1c (e.g. a glycosylated polypeptide such as N-glycosylated-Val-His-Leu-Thr-Pro).

The components of the electrochemical sensors of the present invention will now be described in further detail.

Electrodes

Any electrode may be used in the electrochemical sensor of the present invention. Electrodes suitable for use in the sensors of the present invention include, for example, carbon paste electrodes, screen-printed carbon electrodes, glassy carbon (GC) electrodes, gold electrodes, platinum electrodes, carbon nanotube electrodes, indium tin oxide electrodes, silicon electrodes, aluminium electrodes, copper electrodes, silver electrodes, graphene electrodes, highly orientated pyrolytic graphite electrodes etc.

Typically, the electrode is a gold electrode or a glassy carbon electrode.

GC electrodes are inexpensive and can be mass produced. They are also very dense, chemically inert, electrically conductive and have a relatively well defined structure. GC electrodes can also be modified by the formation of stable layers or monolayers, for example, stable self assembled monolayers (SAMs) and self assembled layers (SALs), on the surface of the electrode using techniques described in the art. Modified GC electrodes have a large potential window, which is advantageous because it allows many different types of molecules to be investigated electrochemically (some molecules are not stable at too negative or too positive potentials).

Protective Layer

The electrode in the sensor of the present invention has a protective layer. The protective layer effectively “insulates” the surface of the electrode by preventing any species which may be present in the sample to be tested from adsorbing on to the electrode. The risk of such interactions interfering with the detection of the analyte in the sample is therefore lessened, which provides a more reliable sensor.

The protective layer may be formed from any substance that will protect the electrode, in that species present in the sample to which the electrode is exposed are prevented from making direct contact with the electrode. The protective layer may, for example, be a layer or monolayer (or a self assembled layer or monolayer) of an organic or inorganic substance.

In some embodiments, the protective layer on the surface of the electrode may be provided by masking the vast majority of the surface of the electrode with blocking agents such as polyethylene glycol (PEG) or oligo(ethylene glycol) (OEG).

In order for the conductive nanoparticles to be bound to the protective layer, at least some groups in the protective layer, or some of the reagents used in the preparation of the protective layer, must be capable of reacting with and binding to surface groups present on the surfaces of the conductive nanoparticles. For example, in some embodiments, the surfaces of an electrode may be modified with 4-aminophenyl as part of the preparation of the protective layer. The terminal amine group of the 4-aminophenyl may then be used to immobilize gold nanoparticles via electrochemical reduction and the formation of a stable C—Au bond.

In some embodiments, the protective layer comprises a layer or monolayer in which molecules of oligo(ethylene glycol) are bound to the electrode along with molecules of 4-thiophenyl and/or 4-aminophenyl. The conductive nanoparticles can then be bound to the electrode by coupling reactions with the thiol group or the amine group in the para position of the phenyl groups bound to the electrode.

The protective layer could also be formed from polymers such as polytyramine, polyphenols, polystyrene, or inorganic species such as silica or silicon dioxide microparticles.

In embodiments where only a portion of an electrode of the present invention will be exposed to a sample, it may not be necessary for the entire electrode to be covered by the protective layer, provided that the portion of the electrode that will be exposed to the sample has a protective layer.

Conductive Nanoparticles

The conductive nanoparticles may be any nanoparticles that enable electrons to be transferred between the electrode and the redox active species. Typically, the conductive nanoparticles are metallic nanoparticles, for example gold nanoparticles (sometimes referred to below as “AuNP”).

The conductive nanoparticles may have any diameter in the nanoparticle range (i.e. from about 1 nm to about 1000 nm). The conductive nanoparticles may, for example, have an average diameter of between about 2 nm and 500 nm, between about 100 nm and about 400 nm, between about 20 nm and about 100 nm, between about 2 nm and about 10 nm or between about 2 nm and about 5 nm. In some embodiments, the conductive nanoparticles may, for example, have an average diameter of about 5 nm, 10 nm, 15 nm, 20 nm, 50 nm, 100 nm, 200 nm, 500 nm or 700 nm.

The size of the conductive nanoparticles and density of the conductive nanoparticles on the sensor of the present invention can be controlled via appropriate synthesis pathways. The inventors believe that the size of the conductive nanoparticles may influence the sensitivity of the sensor for detecting the binding event. As would be appreciated, the density of the conductive nanoparticles on the sensor's surface will influence the magnitude of the electrochemistry that is detectable by the sensor. Hence, sensors having different sensitivities can be prepared.

The redox active species is bound to the conductive particle and is electrochemically accessible to the electrode so that changes in the redox state of the species can be detected by changes in the electrical current in the electrode. Typically, the redox active species is directly bound to the conductive nanoparticle (either directly or via a short length tether), which provides a means by which electrons can move between the redox active species and the electrode, notwithstanding the protective layer separating the conductive nanoparticle and the electrode.

In the preparation of the sensors of the present invention, the surface of the conductive nanoparticle is typically modified such that it includes functional groups (e.g. carboxylic acid functional groups) that are capable of reacting with another compound. Thus, when the conductive nanoparticle is bonded to the protective layer via a first reaction (e.g. a coupling reaction), a redox active species possessing an appropriate functional group (e.g. an amine functional group) may be bonded to the conductive nanoparticle (and therefore to the electrode) via a second reaction such that the electrode and redox active species are joined via the conductive nanoparticle.

Redox Active Species

The redox active species may be any species that can be electrochemically interrogated. The redox active species must be electrochemically accessible to the electrode in order for electrons to be transferred between the species and the electrode, so that changes in the redox state of the redox active species can be detected by changes in the electrical current through the electrode.

In some embodiments, the binding moiety may itself contain a redox active species. In such embodiments, the sensor need not have an additional redox active centre (i.e. the redox active species is part of the binding moiety).

General examples of suitable redox active species include organometallic complexes, metal ion complexes, organic redox active molecules, metal ions and nanoparticles containing a redox active centre.

Typically, the redox active species is chemically bound to the surface of a conductive nanoparticle (as described above), and therefore bound, via the conductive nanoparticle, to the electrode.

In the sensors of the present invention, the redox active species and the binding moiety are typically situated sufficiently proximate to each other so that the association of the binding moiety with the analyte affects the electrochemistry of the redox active species. For example, the redox active species may be directly bound to the binding moiety. Alternatively, the redox active species may be bound to the binding moiety via a short (e.g. C₁₋₁₀) alkyl chain, or the like. In some embodiments, the redox active species is bound to the binding moiety via a C₁₋₅ alkyl chain.

The redox active species in the sensor of the present invention is typically the redox active centre in a redox active compound, where the redox active compound is capable of undergoing chemical reactions in order to bind the redox active centre to other components of the sensor. Compounds that may be used typically have one or more functional groups that enable them to bind to other components of the sensor (e.g. the binding moiety or conductive nanoparticle) via chemical bonds. Preferred redox active compounds that may be used possess amine functional groups, which facilitate the attachment of the compound to other components of the sensor. For example, ferrocenedimethylamine and flavin adenine dinucleotide are redox active compounds that can react with, and be covalently attached to, other compounds via amide coupling(s). The redox active centre in ferrocenedimethylamine is referred to below as the “ferrocene moiety”.

Specific examples of compounds that may be used to incorporate the redox active species in the sensor of the present invention include ferrocenedimethylamine, 1,5-diaminonaphthalene, pyrrolo quinoline quinone, 2,3,5,6-tetramethyl-1,4-phenylenediamine, flavin adenine dinucleotide, ethidium, ruthenium(NH₃)₄pyridine²⁺, ruthenium(2,2′bipyridyl)₂(dipyrido[3,2:α-2′,3′:γ]phenazine)²⁺, ruthenium((5-glutaric acid monohydride)-1,10-phenanthroline)₂(dipyrido[3,2:α-2′,3′:γ]phenazine)²⁺, ruthenium(2,2′-bipyridyl)₄(imidazole)(2-amino-2-deoxyuridine), rhodium(9,10-phenanthrolinequinone diimine)₂((5-glutaric acid monohydride)-1,10-phenanthroline)³⁺, rhodium(2,2′-bipyridyl)₂(5,6-chrysenequinone diimine)³⁺, osmium(1,10-phenanthroline)₂(dipyrido[3,2:α-2′,3′:γ]phenazine)²⁺, 5,10,12,20-tretrakis(1-methyl-4-)porphyrin, 5,10,12,20-tretrakis(-2-pyridinio)porphyrin, and 3-nitrobenzothiazolo[3,2-α]quinoliumchloride.

Binding Moiety

The binding moiety in the electrochemical sensors of the present invention is capable of associating with the analyte in a manner whereby the electrochemistry of the redox active species is modulated (e.g. increased or suppressed). Typically, the association of the binding moiety and analyte is affinity based, that is, the binding moiety and analyte have an affinity for binding to each other. In such cases, the binding typically occurs as a result of the binding moiety or the analyte (the “recognition molecule”) having the correct spatial conformation for the analyte or the binding moiety to bind whereupon a combination of intramolecular bonding forces, such as hydrogen bonding, van der Waals forces and other electrostatic forces, operate cooperatively to strongly bind the analyte and binding moiety together. This is illustrated by antibody-antigen binding events, where variation in up to 17 amino acids in the fragment antigen-binding (Fab) domains of the antibodies allow an alteration in the geometry of the binding pocket of the antibody as well as the relative balance of binding forces that operate in the binding site.

The sensors of the present invention may be used to detect the presence of any analyte to which the binding moiety is capable of associating (e.g. because of an affinity based binding event).

In addition to antibody/antigen binding events, other affinity based binding events include those between lectins and sugars, peptides and proteins, macrocyclic ligands and organic molecules. The sensors of the present invention can be used to transduce these binding events in order to detect such analytes in a sample, for example, sensors in accordance with the present invention can be used to detect lectins or sugars in a sample, peptides or proteins in a sample, or macrocyclic ligands or organic molecules in a sample. Sensors in accordance with the present invention can, for example, be used to detect one of an antibody/antigen pair (e.g. biotin/antibiotin, endosulfan/antiendosulfan, HbA1c/anti-HbA1c IgG, bisphenol A/antibisphenol A antibodies, pollutants such as 2,4-dinitrophenol(DNP)/antiDNP, 2,3,7,8-tetrachlorodibenzofuran (TCBF)/antiTCBF, 2,3,7,8-tetrachloro-dibenzo-p-dioxin (TCDD)/AntiTCDD, 3,3′,4,4′,5,5′-hexachlorodibiphenyl (HCBP)/antiHCBP, drugs (theophylline/antitheophylline), bactericides (enrofloxacin/antienrofloxacin) and pesticides such as atrazine/antiatrazine, and parathion/antiparathion).

As discussed above, if the electrochemical sensor of the present invention is to be used to detect antigen analytes, the binding moiety typically comprises an antibody which is capable of binding to the antigen by dissociating from the sensor. This type of sensor will be referred to below as “the first sensor”.

If the electrochemical sensor of the present invention is to be used to detect antibody analytes, the binding moiety typically comprises at least part of an antigen to which the antibody is capable of binding. This type of sensor will be referred to below as “the second sensor”.

In the first sensor, the binding moiety comprises an antibody which is capable of binding to the antigen. Preferably, the first sensor further comprises at least part of an antigen to which the antibody is capable of binding (an “antigen analogue”), and the antibody binding moiety is releasably attached to the sensor because it is releasably bound to the antigen analogue. The antigen analogue is typically a relatively small species so that the electrochemistry of the redox active species is significantly less suppressed once the antibody binding moiety has detached from the sensor.

In order for the antibody binding moiety of the first sensor to be situated sufficiently proximate to the redox active species such that detachment of the antibody binding moiety from the sensor affects the electrochemistry of the redox active species, the antigen analogue may, for example, be bonded directly to the redox active species. Alternatively, the antigen analogue may be bonded to the redox active species via a short length (e.g. C₁₋₁₀) alkyl chain or the like.

In the second sensor, the binding moiety comprises at least part of an antigen to which the antibody analyte is capable of binding. The binding moiety of the second sensor typically comprises an epitope capable of binding to the antibody analyte. In some embodiments, the binding moiety is the epitope. In embodiments of the second sensor where the binding moiety comprises an epitope, the epitope provides a very high degree of selectivity for the relevant antibody analyte, and the sensor is less susceptible to interference by other species which may be present in the sample to be tested.

In some embodiments, the epitope may be chemically synthesized. That is, the binding moiety may be a chemical analogue of an epitope of the antigen. Alternatively, the epitope may be isolated from the antigen.

The binding moiety in the second sensor is preferably a relatively small species so as not to suppress the electrochemistry of the redox active species when the binding moiety is not bound to the antibody analyte. Thus, in embodiments where the binding moiety is at least part of an antigen to which the antibody analyte is capable of binding, and where the antigen is a small molecule, the antigen itself may be part of the sensor (i.e. the binding moiety is the antigen itself).

The binding moiety in the second sensor is typically situated sufficiently proximate to the redox active species so that the binding of the antibody analyte to the binding moiety affects the electrochemistry of the redox active species. As such, the binding moiety may, for example, be bonded directly to the redox active species. Alternatively, the binding moiety may be bonded to the redox active species via a short length alkyl chain (e.g. C₁₋₁₀) or the like.

The second sensor is capable of performing the “competitive inhibition assay” discussed above. In the “competitive inhibition assay”, the species that is sought to be detected will not itself bind to the second sensor but the antibody of that species will. Thus, the binding moiety of the second sensor is capable of associating with an antibody of the species which results in the electrochemistry of the redox active species being affected. Such sensors may be used to detect the presence of any antibody of the species to which the binding moiety is capable of associating.

Whilst the binding moiety of the second sensor should preferably be a relatively small species so as not to suppress the electrochemistry of the redox active species when the binding moiety is not bound to the antibody, the inventors have surprisingly found that relatively large species, such as peptides containing 5 to 10 amino acids, can be used as the binding moiety without suppressing the electrochemistry of the redox active species. Thus, in some embodiments, the binding moiety comprises a sequence of amino acids. For example, the inventors have found that a suitable binding moiety for detecting an antibody of HbA1c is a N-glycosylated pentapeptide such as N-glycosylated-Val-His-Leu-Thr-Pro.

Other Components

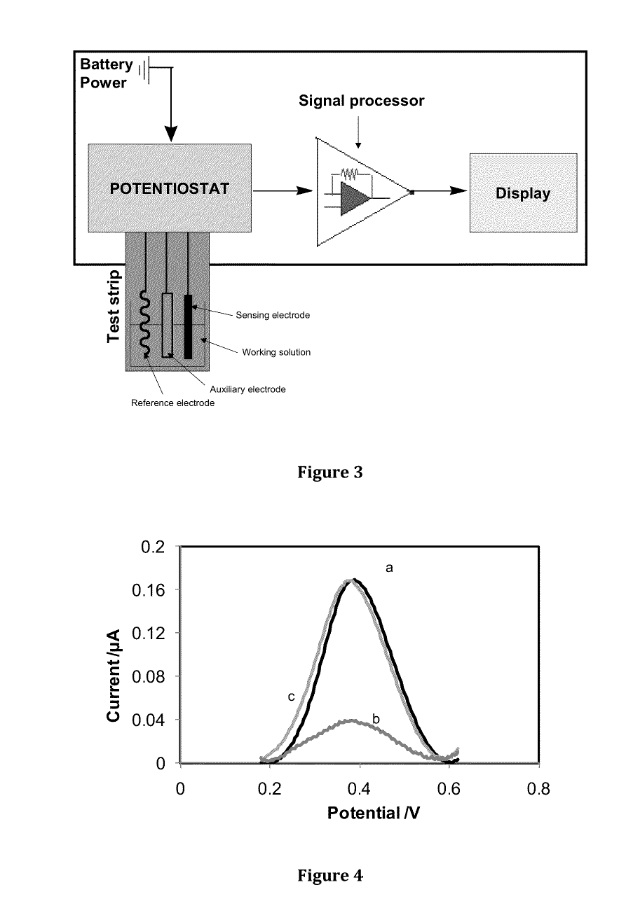

The amperometric sensors of the present invention will typically include additional components that enable the results of the sample analysis to be viewed by the operator. For example, the sensor would typically include a source of electricity (such as a battery), a potentiostat, a signal processor and/or a display for displaying electrochemical readings from the electrode. The electrode having the components described above would typically be provided as part of a test strip comprising the electrode having the components described above, a reference electrode and an auxiliary electrode. A schematic representation of such a sensor is depicted in FIG. 3. In use, the test strip would be exposed to the test sample (e.g. a body of water, a patient's blood, a foodstuff, a drink, or an industrial or household waste sample).

In some embodiments, the sensor further comprises a detector capable of detecting changes in the electrochemistry of the redox active species as a result of the association of the binding moiety with the analyte. The change in the electrochemistry of the redox active species is typically detected by analysing changes in the ability of the electrode to oxidise and reduce the redox active species as the potential of the electrode is scanned anodically and cathodically respectively.

The sensors of the present invention will typically include a large number of redox active species and binding moieties distributed on the surface of the electrode in order for the association of the binding moiety and the analyte to cause a detectable change in the electrochemistry of the redox active species. In some embodiments, the sensor may include a plurality of different redox active species and/or binding moieties.

As used herein, a reference to exposing a sensor of the present invention to a sample, refers to exposing the sensor to the sample in a manner that would permit the binding moiety to associate with any of the analyte that may be present in the sample. Typically, in a sensor of the present invention, the redox active species is bound to the conductive nanoparticles bound to the protective layer on the electrode, and the binding moiety is bound to the redox active species, and the sensor is exposed to the sample by placing at least part of the electrode in the sample, thereby enabling the binding moiety to associate with any of the analyte present in the sample.

Formation of Electrochemical Sensors

The chemistry and processes relating to the formation of layers, monolayers, self assembled monolayers (SAMs) and self assembled layers (SALs) on the surface of an electrode is well-known.

A process for forming on a GC electrode a SAL onto which a redox active species and a binding moiety are immobilised will now be described to illustrate how a sensor in accordance with a preferred embodiment of the present invention can be prepared. Layers or monolayers may be formed on the surfaces of other types of electrode using techniques well known in the art.

A label-free immunosensor to detect HbA1c in a sample of human blood based on the modulation of the electrochemistry of a surface bound redox species was prepared as follows. Glassy carbon (GC) electrode surfaces were first modified with 4-aminophenyl to produce GC-Ph-NH₂. The terminal amine groups were then converted to diazonium groups by incubating the GC-Ph-NH₂ interface in a solution containing NaNO₂ and HCl to form the 4-phenyl diazonium chloride modified interface GC-Ph-N₂⁺Cl⁻. Subsequently, gold nanoparticles (AuNP) were immobilized on the interface by electrochemical reduction and the formation of a stable C—Au bond to achieve the AuNP modified interface GC-Ph-AuNP. Oligo(ethylene glycol) (OEG) molecules were then covalently attached to the GC interface to complete the protective layer for resisting any non-specific protein adsorption on the electrode surface.

The AuNP surfaces were then modified to include 4-carboxyphenyl groups using diazonium salt chemistry. 1,1-Di(aminomethyl)ferrocene (FDMA) was then attached to the carboxylic acid groups on the AuNP surfaces by reacting the first amine group of the FDMA with the carboxylic acid groups. The epitope, glycosylated pentapeptide (GPP), an analogon to HbA1c, was then covalently bound to the FDMA via the remaining free amine of the FDMA to produce the GC-Ph-AuNP/OEG/Ph-CP/FDMA/GPP sensing interface.

As will be described below in the Examples, complexation of anti-HbA1c IgG with the surface bound epitope GPP results in attenuation of the ferrocene electrochemistry. The formed sensing interface demonstrates high selectivity, stability, and sensitivity to anti-HbA1c IgG, and can be used for the detection of HbA1c as a percentage of total haemoglobin in the range of 4.6%-15.1% in human blood via a competitive inhibition assay.

Methods of the Present Invention

In a second aspect, the present invention provides a method for detecting the presence of an analyte in a sample. The method comprises the steps of exposing the electrochemical sensor of the first aspect of the present invention to the sample and taking amperometric electrochemical measurements which indicate whether the electrochemistry of the redox active species has been modulated.

The association of the analyte with the binding moiety affects the electrochemistry of the redox active species, and thus causes an alteration in the ability of the electrode to oxidise and reduce the redox active species. For example, upon sweeping the potential of the electrode of a sensor of the present invention progressively more positive (cyclic voltammetry), or stepping the potential progressively more positive (square wave voltammetry), the redox active species becomes more susceptible to oxidation and eventually oxidises (e.g. a ferrocene moiety will be oxidised to the ferricinium ion). In the voltammograms, this is represented by an increase in anodic current as electrons transfer to the electrode. Sweeping the potential back more negatively will result in the reduction of the redox active species (e.g. the reduction of the ferricinium ion to the ferrocene moiety) as electrons transfer from the electrode to the redox active species. The association of the binding moiety with the analyte will affect the ability of the electron transfer to occur, increasing or diminishing the peaks observed in the voltammograms.

The second sensor of the present invention can be used to detect the presence of an antibody (e.g. antibiotin) in a sample by taking electrochemical measurements which indicate whether there is a change in the electrochemistry of the redox active species (e.g. a ferrocene moiety) as a result of the antibiotin binding to the binding moiety (e.g. biotin), as will now be described

The electrode of the sensor is immersed for 20 mins in a test sample. During this time, if there is any antibiotin in the sample, at least some of the antibiotin will bind to the biotin on the sensor, resulting in the electrochemistry of the ferrocene moiety being suppressed. This decrease in electrochemistry is detectable and can be quantified using electrochemical techniques well known in the art.

The first sensor of the present invention can be used to detect the presence of an antigen (e.g. biotin) in a sample by taking electrochemical measurements which indicate whether there is a change in the electrochemistry of the redox active species (e.g. a ferrocene moiety) as a result of the binding moiety (e.g. antibiotin, which is bound to the sensor via a biotin molecule) disassociating from the sensor, as will now be described.

The electrode of the sensor is immersed for 20 mins in a test sample. During this time, if there is any biotin in the sample, at least some of the antibiotin bound to the sensor will detach from the biotin on the sensor and bond to the free biotin in the sample. As a result of the antibiotin detaching from the sensor, the electrochemistry of the ferrocene moiety will increase because it is no longer engulfed by the antibiotin and ions may now interact with it. This increase in electrochemistry is detectable and can be quantified using electrochemical techniques well known in the art.

It is also possible to quantify the amount of analyte present in a sample using the present invention. For example, when the analyte is an antibody and the binding moiety its antigen, interaction between the sensor and the complementary antibody results in the antibody binding to the binding moiety. The formed bulky structure of the binding moiety/antibody biomolecular pair perturbs the electrical communication between the redox active species and the sample, and the resulting amperometric signal is inhibited. The extent of the electrode coverage by the antibody is proportional to the antibody concentration in the sample and to the time for which the electrode is exposed to the sample. Thus, if the duration of exposure to the sample is fixed, the decrease in the electrode amperometric response correlates with the antibody concentration in the sample.

Typically, the electrochemical measurements are taken at the same time that the sensor is exposed to the sample, that is, at the same time that the binding moiety associates with the analyte (i.e. association of the binding moiety with the analyte is electrochemically contemporaneously detected). This can significantly simplify the detection process and enable an unskilled operator to test the samples.

In some embodiments, the method is used to perform a “competitive inhibition assay”. In such embodiments, the “analyte” is, in fact, an antibody of a “second analyte” (i.e. the species that is sought to be detected) and the method comprises a preliminary step of adding the antibody of the second analyte to the sample before the sensor is exposed to the sample. In some embodiments, the electrochemical measurements are used to quantify the amount of the antibody of the second analyte which associates with the binding moiety. In some embodiments, the method comprises the further step of calculating the amount of the second analyte in the sample based on the amount of the antibody of the second analyte which associates with the binding moiety (and knowing the amount of the antibody of the second analyte which was added to the sample).

In the “competitive inhibition assay”, any of the second analyte present in the sample competes with the binding moiety for the antibody that was added to the sample. By comparing the amount of antibody added to the sample with the amount of antibody which associates with the binding moiety (and is thus detectable by taking amperometric electrochemical measurements), an indication of the presence and amount of the second analyte present in the sample can be obtained.

The “competitive inhibition assay” of the present invention can, for example, be used to determine the presence and amount of many second analytes in a sample (provided that an antibody of the analyte can be accessed). Exemplary second analytes include: proteins such as HbA1c, prostate specific antigen, tau, ICAm-1, VEGF, interleukins, tissue necrosis factors, lipoproteins, HER2, human chorionic gonadotropin, cancer antigen-125, kinases, pathogens and protozoa such as cryptosporium parvum, giardia, staphylococcus aureus, vibrio cholerae, and viruses such as rotavirus, enterovirus, norovirus and hepatitis A.

The “competitive inhibition assay” of the present invention can, for example, be used to detect HbA1c (i.e. the “second analyte” is HbA1c). As discussed above, HbA1c is a useful protein for clinically monitoring a person's average blood sugar level over the preceding 2 to 3 months. Thus, in some embodiments, the method of the second aspect of the present invention can be used to determine blood glucose levels of a patient over an extended period of time in order to assist in the management of that person's diabetes.

In a third aspect, the present invention provides a method for determining blood glucose levels in a patient. The method comprises the steps of adding to a sample of the patient's blood an antibody of HbA1c; exposing to the sample a sensor of the first aspect of the present invention (in which the binding moiety is capable of associating with the antibody of Hb1Ac); and taking amperometric electrochemical measurements which indicate whether the electrochemistry of the redox active species has been modulated because of the binding moiety associating with the antibody of HbA1c.

Typically, as part of determining a patient's average blood glucose levels, the electrochemical measurements will be used to quantify the amount of the antibody of HbA1c which associates with the sensor. From this, a further step may be conducted in which the amount of HbA1c in the sample is calculated based on the amount of the antibody of HbA1c that associated with the sensor.

Typically, the method is repeated at predetermined time intervals (e.g. every 2 to 3 months) in order to record the patient's blood glucose levels over time. In this manner, any changes in the patient's blood glucose levels can be carefully analysed in order to ascertain whether the patient's treatment regimen is appropriate.

In order to provide an additional degree of specificity, in some embodiments, the binding moiety is an epitope for an antibody of HbA1c. One suitable class of epitopes are glycosylated polypeptides, for example, N-glycosylated-Val-His-Leu-Thr-Pro.

In a preferred embodiment of the method of the third aspect of the present invention, the competitive inhibition assay is adapted for the detection of HbA1c using a N-glycosylated pentapeptide (GPP) as an HbA1c analogon. The immunosensing methods of the present invention are based on detecting and measuring the modulation of amperometric signals of surface bound ferrocene moieties when immersed in a protein environment. Transduction is based on the amperometric signal of the surface bound ferrocene moiety being attenuated when the antibody of HbA1c binds to the epitope due to the immersion of the sensor into a protein environment.

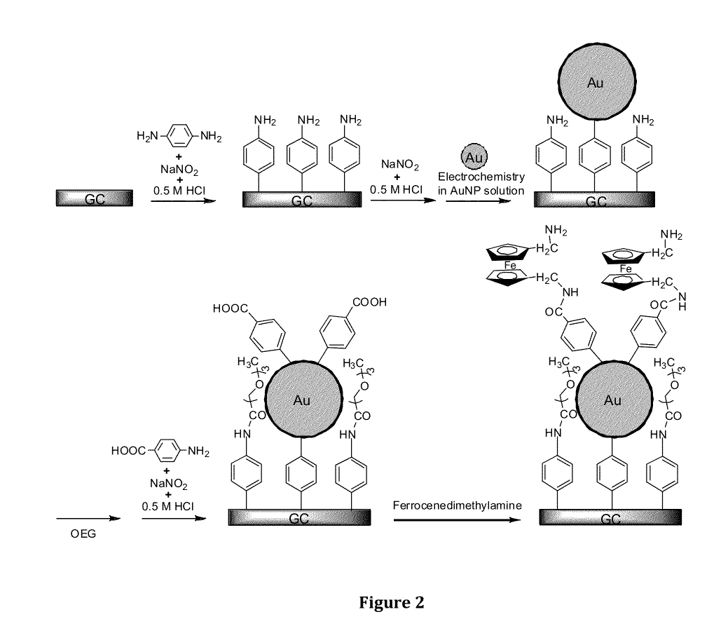

A schematic drawing of the steps in the manufacturing process of a sensor adapted to perform the competitive inhibition assay is shown in FIG. 2. A schematic drawing of the use of the sensor of FIG. 2 for the detection of HbA1c is shown in FIG. 1c. The left hand side of the bottom line of FIG. 1c depicts a sensor for use in the competitive inhibition assay. The right hand side of the bottom line of FIG. 1c depicts the sensor after the antibody (HbA1c monoclonal antibody) has been added to the sample and the sensor exposed to the sample. As can be seen, the HbA1c monoclonal antibody has bound to the HbA1c in the sample as well as to the epitope on the sensor.

It should be noted that the antibody in these representations is depicted for clarity as being approximately only slightly larger than the binding moiety (N-glycosylated-VHLTP). The antibody would typically be many times larger than the binding moiety.

### EXAMPLES

Reagents and Materials

HbA1c control samples of four levels of glycosylated hemoglobin were obtained from Kamiya Biomedical company (USA), and used without further purification. N-glycosylated pentapeptide (N-glycosylated-Val-is-Leu-Thr-Pro, purity by HPLC>97.5%) was purchased from Tocris bioscience (UK). Human HbA1c monoclonal antibody IgG was supplied from Abnova (USA). Ferrocenedimethylamine (FDMA) was synthesized using the procedure from Ossola (Ossola, F., et al, Inorgan. Chim. Acta 2003, 353, 292-300). Reagent grade dipotassium orthophosphate, potassium dehydrogenate orthophosphate, potassium chloride, sodium hydroxide, sodium chloride, sodium nitrite, hydrochloric acid, methanol, and diethyl ether were purchased from Ajax Chemicals Pty Ltd. (Sydney, Australia). Ruthenium(III) hexamine chloride (Ru(NH₃)₆Cl₃), 2[2-(2-methoxyethoxy)ethoxy]acetic acid (OEG), 1-ethyl-3-(3-dimethylaminopropyl)carbodiimide hydrochloride (EDC), N-hydroxysuccinimide (NHS), 1,3-dicyclohexylcarbodiimide (DCC), 4-phenyldiamine, 4-aminobenzoic acid, hemoglobin, bovine serum albumin (BSA), anti-pig IgG, anti-biotin IgG from goat, and absolute ethanol were obtained from Sigma-Aldrich (Sydney, Australia). All reagents were used as received, and aqueous solutions were prepared with purified water (18 MΩ/cm, Millipore, Sydney, Australia). Phosphate buffered saline (PBS) solutions were 0.137 M NaCl and 0.1 M K₂HPO₄/KH₂PO₄ and adjusted with NaOH or HCl solution to pH 7.3. Phosphate buffer solutions used in this work were 0.05 M KCl and 0.05 M K₂HPO₄/KH₂PO₄ and adjusted with NaOH or HCl solution to pH 7.0. All cyclic voltammetry and square wave voltammetry were carried out in pH 7.0 phosphate buffer.

Electrode Preparation

GC electrodes were purchased as 3-mm-diameter disks from Bioanalytical Systems Inc., USA. The electrodes were polished successively with 1.0, 0.3, and 0.05 μm alumina slurries made from dry Buehler alumina and Milli-Q water on microcloth pads (Buehler, Lake Bluff, Ill., USA). The electrodes were thoroughly rinsed with Milli-Q water and sonicated in Milli-Q water for 2 min after polishing. Before derivatization, the electrodes were dried under an argon gas stream.

Preparation of HbA1c Control Samples

The lyophilized HbA1c control samples are a hemolysate prepared from packed human erythrocytes, with stabilizers added to maintain hemoglobin in the reduced state for the accurate calibration of the HbA1c procedure. Each lyophilized control sample was reconstituted by adding 0.5 mL Milli-Q water, and the mixture was mixed gently for 10 min and stored at 4° C. as a stock solution. The glycosylated hemoglobin levels were 4.6%, 8%, 12.4% and 15.1%, respectively, of total hemoglobin (glycosylated and non-glycosylated) concentration for each control sample. Samples with other glycosylated hemoglobin level were prepared by mixing control sample R1 (4.6%) and control sample R4 (15.1%) stock solutions with different ratio. To perform the competitive inhibition assay, samples with HbA1c analyte were preincubated with 2 μg mL−1 anti-HbA1c IgG for 30 min. Then 5 μL of mixture of HbA1c and anti-HbA1c IgG were applied to the working area of GPP terminated GC electrode surfaces for 5 min followed by electrochemistry measurement.

Instrumentation and Procedure

All voltammetry measurements were performed with a BAS-100B electrochemical analyser (Bioanalytical System Inc. Lafayette, Ill.) and a conventional three-electrode system, comprising a gold working electrode, a platinum foil as the auxiliary electrode, and a Ag/AgCl 3.0 M NaCl electrode (from BAS) as reference. All potentials were reported versus the Ag/AgCl reference electrode at room temperature.

### Example 1

### Fabrication of the Amperometric Immunosensor Based on Gold Nanoparticle-Diazonium Salt Modified Sensing Interface

The schematic of fabrication of the amperometric immunosensor for the detection of HbA1c is shown in FIG. 2. GC electrodes were first modified with 4-aminophenyl (GC-Ph-NH₂), and then the terminal amine groups were converted to diazonium groups by incubating the GC-Ph-NH₂ interface in NaNO₂ and HCl solution to form a 4-phenyl diazonium chloride modified interface (GC-Ph-N₂⁺Cl⁻). Subsequently gold nanoparticles (AuNP) were immobilized on the interface by electrochemical reduction and the formation of a stable C—Au bond to achieve a 4-phenyl AuNP modified interface (GC-Ph-AuNP). Then, the GC-Ph-AuNP modified surface was incubated in absolute ethanol solution containing 10 mM OEG and 40 mM DCC for 6 h at room temperature to form the OEG modified GC surfaces (GC-Ph-AuNP/OEG).

Subsequently, surface attached AuNP was further functionalized with 4-carboxyphenyl by scanning potential between 0.5 V and −0.5 V at 0.5 M HCl solution containing 1 mM NaNO₂ and 1 mM 4-aminobenzoic acid for two cycles at the scan rate of 100 mV s⁻¹ to form GC-Ph-AuNP/OEG/Ph-CP surfaces. Covalent attachment of FDMA to the carboxylic acid terminated surfaces was then achieved by incubating the GC-Ph-AuNP/OEG/Ph-CP surfaces into absolute ethanol containing of 40 mM DCC and 5 mM FDMA for 6 h at room temperature. Any nonspecific adsorption of FDMA was removed by sonication in Milli-Q water for 2 min or continuous cycling between 0 V and 0.8 V in phosphate buffer until obtaining the stable electrochemistry. After attachment of FDMA, the GC electrode surfaces covered with amine terminal groups were immersed into 2 mM solution of GPP (N-glycosylated-Val-His-Leu-Thr-Pro) in phosphate buffered pH 6.8 containing of 20 mM EDC and 10 mM NHS for 4 h at 4° C. to attach GPP to form GC-Ph-AuNP/OEG/Ph-CP/FDMA/GPP surfaces. Then GPP terminated surface can be used as the sensing interfaces of the competitive inhibition assay for the detection of HbA1c in human blood.

### Example 2

### Electrochemistry of the Amperometric Immunosensor Based on AuNP-Diazonium Salt Modified Sensing Interface

After the attachment of GPP to the sensor of Example 1, the electrochemistry of FDMA modified GC electrode surfaces showed only minor change in peak currents indicating the peptide does not block the surface electrochemistry, a necessary condition for the sensor to be able to operate. However, as can be seen in FIG. 4, complexation of anti-HbA1c IgG with the GC-Ph-AuNP/OEG/4-CP/FDMA/GPP results in an obvious attenuation of the ferrocene electrochemistry (b). Current attenuation suggests changes in the interfacial microenvironment arising from formation of an immunocomplex on the electrode surface. Formation of the complex is hypothesized to restrict counterion access to the ferrocene probe with a corresponding decrease in current.

Non-specific adsorption is a key issue for a label-free immunosensor. In order to check if there is any non-specific binding to the GPP terminated sensing interface, incubation of the sensing interface with 1 μg mL⁻¹ BSA as a different protein for 3 h at room temperature did not show significant current change (c) indicating the sensing interface can resist the non-specific adsorption of protein due to the presence of OEG molecules.

To study the selectivity, the sensing interface was exposed to anti-HbA1c IgG which has high affinity with GPP, and anti-biotin IgG or anti-pig IgG as the antibody which has no affinity with GPP. After the incubation of GC-Ph-AuNP/OEG/4-CP/FDMA/GPP surface with 100 ng mL−1 anti-HbA1c IgG, the current decreased by 75%±6% (95% confidence, n=5). However, there is almost no change on the current with the increase of concentration of anti-biotin IgG or anti-pig IgG indicating the sensing interface is not sensitive to the non-specific antibody adsorption such as anti-biotin IgG or anti-pig IgG. With the ability of resisting non-specific protein adsorption, the modified sensing interface has good selectivity to anti-HbA1c IgG.

The calibration curve for the detection of HbA1c in the control sample which contents the clinical concentration of hemoglobin is investigated by the competitive inhibition assay. When GC-Ph-AuNP/OEG/4-CP/GPP surface is exposed to the mixture of anti-HbA1c IgG and HbA1c, some anti-HbA1c IgG are expected to bind to GPP on the sensing interface due to the competitive binding of anti-HbA1c IgG between the analyte HbA1c and surface epitope GPP, resulting in the current suppression from the surface bound redox species FDMA. Less suppression in current is expected when the immunosensor is exposed to anti-HbA1c IgG containing higher concentration of HbA1c in serum samples indicating that less antibodies are being bound to the interface. Thus the magnitude of current attenuation is expected to be different if the anti-HbA1c IgG is mixed with HbA1c at different concentrations, and a calibration curve is to be obtained.

The performance of the modified amperometric immunosensor of Example 1 was compared with a clinical method used at a commercial pathology clinic in Sydney for the detection HbA1c in human blood donated by a healthy adult. The HbA1c result from the amperometric immunosensor of Example 1 was comparable to that obtained from the clinical method.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that a reference herein to a prior art publication herein does not constitute an admission that the publication forms a part of the common general knowledge in the art, in Australia or any other country.

1. An electrochemical sensor comprising:
an electrode having a protective layer;
conductive nanoparticles bound to the protective layer;
a redox active species bound to the conductive nanoparticles; and
a binding moiety capable of associating with an analyte, the binding moiety being associated with the redox active species bound to the conductive nanoparticles, whereby association of a binding moiety with the analyte modulates the electrochemistry of the redox active species associated with the binding moiety.

2. The sensor of claim 1, wherein the analyte is an antigen and the binding moiety comprises an antibody for the antigen, and whereby an antibody dissociates from the redox active species in order to associate with the antigen, such dissociation increasing the electrochemistry of the redox active species.

3. The sensor of claim 1, wherein the analyte is an antibody and the binding moiety comprises at least part of an antigen for the antibody, and whereby binding of an antibody to the at least part of an antigen suppresses the electrochemistry of the redox active species.

4. The sensor of claim 3, wherein the analyte is an antibody of HbA1c, and wherein the binding moiety comprises an epitope for an antibody of HbA1c.

5. The sensor of claim 4, wherein the binding moiety comprises N-glycosylated-Val-His-Leu-Thr-Pro.

6. The sensor of claim 1, wherein the conductive nanoparticles are metallic nanoparticles.

7. The sensor of claim 1, wherein the conductive nanoparticles are gold nanoparticles.

8. The sensor of claim 1, wherein the conductive nanoparticles have an average diameter of between about 2 nm and 50 nm.

9. The sensor of claim 1, wherein the electrode is a gold electrode or a glassy carbon electrode.

10. The sensor of claim 1, wherein the protective layer comprises oligo(ethylene glycol) bound to the electrode and para-substituted phenyl groups bound to the electrode and the conductive nanoparticles.

11. The sensor of claim 1, further comprising a detector capable of detecting changes in the electrochemistry of the redox active species as a result of the association of the binding moiety with the analyte, an electrical power source and a display for displaying electrochemical readings from the electrode.

12. A method for detecting the presence of an analyte in a sample, the method comprising the steps of:
exposing the electrochemical sensor of claim 1 to the sample; and
taking amperometric electrochemical measurements which indicate whether the electrochemistry of the redox active species has been modulated.

13. The method of claim 12, wherein the electrochemical measurements are taken at the same time that the sensor is exposed to the sample.

14. The method of claim 12, wherein the analyte is an antibody of a second analyte and the method comprises a preliminary step of adding the antibody of the second analyte to the sample before the sensor is exposed to the sample.

15. The method of claim 14, wherein the electrochemical measurements are used to quantify the amount of the antibody of the second analyte which associates with the binding moiety.

16. The method of claim 14, wherein the second analyte is HbA1c.

17. The method of claim 16, when used to determine blood glucose levels of a patient over an extended period of time.

18. A method for determining blood glucose levels in a patient, the method comprising the steps of:
adding to a sample of the patient's blood an antibody of HbA1c;
exposing to the sample a sensor of claim 1 in which the binding moiety is capable of associating with the antibody of Hb1Ac; and
taking amperometric electrochemical measurements which indicate whether the electrochemistry of the redox active species has been modulated by the binding moiety associating with the antibody of HbA1c.

19. The method of claim 18, wherein the electrochemical measurements are used to quantify the amount of the antibody of HbA1c which associates with the sensor, and comprising the further step of calculating the amount of HbA1c in the sample based on the amount of the antibody of HbA1c which associates with the sensor.

20. A kit for detecting an analyte in a sample, the kit comprising a sensor of claim 1 and an analyte that is an antibody of a second analyte.
